(19) United States
(12) Patent Application Publication
(10) Pub. No.: US 2007/0062031 A1
(43) Pub. Date: Mar. 22, 2007

(54) Printed circuit board including a fuse

(75) Inventor: Remy Jacobus Wilhelmus Kamp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/575,511

(22) PCT Filed: Oct. 7, 2004
(86) PCT No.: PCT/IB04/52022

§ 371 Date: Apr. 13, 2006

(30) Foreign Application Priority Data
Oct. 17, 2003 (EP) 03103846.6

(51) Int. Cl. B23P 19/00

(52) U.S. Cl. 29/739

(57) ABSTRACT

Printed circuit board comprising a substrate, a plurality of electronic components, and a pattern of metal tracks (1) on said substrate for connecting said electronic components, said metal tracks, typically copper, being covered with a protective layer, typically a solder resist layer, wherein said board further comprises a fuse, said fuse comprising a narrowed metal track (3) within the pattern, wherein said narrowed metal track is uncovered such that it is exposed to air.

The invention relates to a printed circuit board comprising a substrate, a plurality of electronic components, and a pattern of metal tracks, typically copper tracks, on said substrate for connecting said electronic components, said metal tracks being covered with a protective layer, typically a solder resist layer, wherein said board further comprises a fuse, said fuse comprising a narrowed metal track within the pattern.

Such a printed circuit board is described in EP-A-0 626 714. The fuse provides a low-cost protection against overheating of the board if an overcurrent occurs. In that case the narrow metal track will heat up and melt, whereby the current will interrupt. A drawback of this solution is that the printed circuit board still can be burned by the heat necessary to melt the metal. The protective non-conductive layer promotes dissipation of the heat into the substrate, which will be severely damaged thereby. Even the danger of a fire outbreak, which the fuse intended to prevent, is not excluded. Therefore the known solution must be considered unreliable.

The aim of the invention is printed circuit board which is protected against fire and damage at low costs in a reliable manner.

According to the invention said narrowed metal track is uncovered such that it is exposed to air. Thereby the heat of the melting metal can dissipate into the air and fire is prevented. Furthermore the absence of solder resist decreases the thermal conductivity of the narrowed metal track, whereby it will melt faster. Also the chances that the solder resist itself catches fire is reduced hereby.

Preferably furthermore an area of at least 0.5 mm, preferably at least 1 mm extending from said narrowed metal track is uncovered, which further improves the heat dissipation of the substrate.

Preferably furthermore a distance of at least 1.5 mm, preferably at least 2 mm of the ends of the wider metal tracks extending from both ends of the narrowed metal track are uncovered. The bigger mass of the wider metal tracks act as further heat dissipating means thereby. Also the absence of solder resist on the ends of the wider copper tracks act as solder thieves during the solder process, such that the narrowed copper track is not overloaded with solder and a smooth, thin solder layer is formed on the narrowed copper track.

The width of the narrowed metal track is preferably less than 0.3 mm, more preferably less than 0.2 mm.

According to another aspect of the invention a slot is provided in the substrate alongside substantially the entire length of the narrowed metal track at both sides thereof. Thereby the thermal conductivity of the narrowed metal track is further decreased. Another important advantage hereof is that spreading of a possible burning of the board near the narrowed track is blocked by said slots. This feature can be considered an invention on its own. Said slots are preferably located at a distance of less than 2 mm, more preferably less than 1.5 mm from the narrowed metal track. The area between the narrowed metal track and the slots is preferably substantially uncovered. The width of the slots is preferably at least 0.5 mm, more preferably at least 1 mm.

The invention also relates to an electronic ballast for a gas discharge lamp comprising a printed circuit board.

The invention furthermore relates to a method for producing a printed circuit board comprising a substrate, a plurality of electronic components, and a pattern of metal tracks on said substrate for connecting said electronic components, said metal tracks being covered with a protective layer, wherein said board is further provided with a fuse by providing a narrowed metal track within the pattern, wherein said narrowed metal track is not covered with a protective layer such that it remains exposed to air.

The invention will be illustrated by the embodiments described hereinafter with reference to the drawings, wherein:

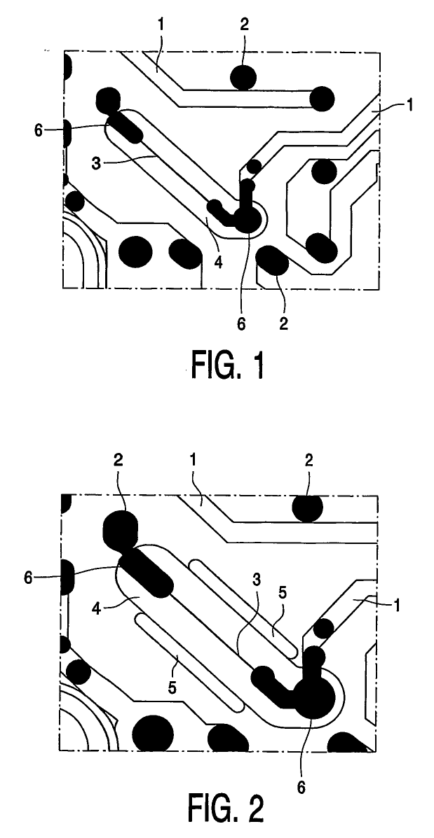

FIG. 1 shows a top plan view of a detail of a first embodiment of a printed circuit board; and

FIG. 2 shows a top plan view of a detail of a second embodiment of a printed circuit board.

According to FIG. 1 a printed circuit board comprises a carrier board or substrate having circuitry of copper tracks 1 for connecting electronic components (not shown) on said board. The width of the copper tracks 1 is typically approximately 1 mm. The connectors of the electronic components extend through holes in the board and are fixed thereon by solder drops 2. To that end the surface of the board, including the copper tracks 1 but excluding the locations where the solder drops are applied, is provided by a solder resist protective coating.

The printed circuit board further comprises a fuse, which is comprised of a narrowed copper track 3 in the circuitry. If an overcurrent runs through this narrowed copper track, it will heat up and melt because of the resistance of the track, whereby the current is interrupted, thus preventing overheating of the board. Typically the width of the narrowed copper track is less than 0.3 mm or 0.2 mm.

In order to promote heat dissipation to the environment in case the copper track is melting, and also to decrease the thermal conductivity of the track, the narrowed copper track 3 and the area 4 around it is not coated with solder resist. This area extends approximately 1 mm at both sides from the narrowed copper track 3, and furthermore it extends approximately 2 mm in longitudinal direction along ends 6 of the wider copper tracks 1 at both ends of the narrowed copper track 3. The uncovered ends 6 of the wider copper track 6 serve as a solder thieve during the solder process, whereby a thin, smooth layer of solder is formed on the narrowed copper track 3 and clogging of solder thereon is prevented.

FIG. 2 shows a further enhancement of the board shown in FIG. 1. On both sides of the narrowed copper track 3 a slot 5 is provided, for instance by milling. The slots 5 are provided along the entire length of the narrowed copper track 3 at a distance of approximately 1 mm thereof. The width of the slots 5 is approximately 1 mm. The area between the track 3 and the slots 5 is uncovered as described with reference to FIG. 1. Through these slots the thermal conductivity of the track 3 is further decreased, resulting in a faster melting of the track and thereby a faster interrupt of the current.

It will be evident that many variations within the scope of the invention can be conceived by those skilled in the art.

1. A printed circuit board comprising a substrate, a plurality of electronic components, and a pattern of metal tracks (1) on said substrate for connecting said electronic components, said metal tracks (1) being covered with a protective non-conductive layer, wherein said board further comprises a fuse, said fuse comprising a narrowed metal track (3) within the pattern, characterized in that said narrowed metal track (3) is uncovered such that it is exposed to air.

2. The printed circuit board according to claim 1, wherein further an area (4) of at least 0.5 mm, preferably at least 1 mm extending from said narrowed metal track (1) is uncovered.

3. The printed circuit board according to claim 1, wherein further a distance of at least 1.5 mm, preferably at least 2 mm of the ends (6) of the wider metal tracks (1) extending from both ends of the narrowed metal track (3) are uncovered.

4. The printed circuit board according to claim 1, wherein the width of said narrowed metal track (3) is less than 0.3 mm, preferably less than 0.2 mm.

5. The printed circuit board according to claim 1, wherein a slot (5) is provided in the substrate alongside substantially the entire length of the narrowed metal track (3) at both sides thereof.

6. The printed circuit board according to claim 5, wherein said slots (5) are located at a distance of less than 2 mm, preferably less than 1.5 mm from the narrowed metal track (3).

7. The printed circuit board according to claim 5, wherein the area (4) between the narrowed metal track (3) and the slots (5) is substantially uncovered.

8. The printed circuit board according to claim 5, wherein the width of the slots (5) is at least 0.5 mm, preferably at least 1 mm.

9. An electronic ballast for a gas discharge lamp comprising a printed circuit board according to claim 1.

10. A method for producing a printed circuit board comprising a substrate, a plurality of electronic components, and a pattern of metal tracks (1) on said substrate for connecting said electronic components, said metal tracks (1) being covered with a protective non-conductive layer, wherein said board is further provided with a fuse by providing a narrowed metal track (3) within the pattern, characterized in that said narrowed metal track (3) is not covered with a protective non-conductive layer such that it remains exposed to air.
